(19) United States
(12) Patent Application Publication
(10) Pub. No.: US 2025/0279112 A1
(43) Pub. Date: Sep. 4, 2025

(54) Quantifying Unintended Memorization in Automated Speech Recognition Encoders

(71) Applicant: Google LLC, Mountain View, CA (US)

(72) Inventors: Virat Vishnu Shejwalkar, Amherst, MA (US); Geeticka Chauhan, Mountain View, CA (US); Steve Chien, Mountain View, CA (US); Abhradeep Guha Thakurta, Mountain View, CA (US); Om Dipakbhai Thakkar, Sunnyvale, CA (US); Arun Narayanan, Milpitas, CA (US)

(73) Assignee: Google LLC, Mountain View, CA (US)

(21) Appl. No.: 19/052,769

(22) Filed: Feb. 13, 2025

Related U.S. Application Data
(60) Provisional application No. 63/560,041, filed on Mar. 1, 2024.

(51) Int. Cl. G10L 25/30; G10L 13/08

(52) U.S. Cl. CPC G10L 25/30; G10L 13/08

(57) ABSTRACT

A method includes receiving a training data set including un-transcribed speech utterances that each include audio-only data not paired with any corresponding transcription, and obtaining a plurality of training canary transcriptions each including a predetermined number of words that are out-of-distribution from words of the un-transcribed speech utterances. For each training canary transcription, the method also includes generating, using TTS system, a corresponding synthetic training canary speech utterance that recites the predetermined number of words of the training canary transcription and pre-training an audio encoder on a combination of the un-transcribed speech utterances and the synthetic training canary speech utterances. The method also includes measuring an un-intended memorization of the pre-trained audio encoder based on encoder labels predicted by the pre-trained encoder for the synthetic training canary speech utterances.

### CROSS REFERENCE TO RELATED APPLICATIONS

This U.S. patent application claims priority under 35 U.S.C. § 119 (e) to U.S. Provisional Application 63/560,041, filed on Mar. 1, 2024. The disclosure of this prior application is considered part of the disclosure of this application and is hereby incorporated by reference in its entirety.

### TECHNICAL FIELD

This disclosure relates to quantifying unintended memorization in automated speech recognition encoders.

### BACKGROUND

Automatic speech recognition (ASR), the process of taking an audio input and transcribing it into text, has greatly been an important technology that is used in mobile devices and other devices. In general, automatic speech recognition attempts to provide accurate transcriptions of what a person has said by taking an audio input (e.g., speech utterance) and transcribing the audio input into text. Modern ASR models continue to improve in both accuracy (e.g. a low word error rate (WER)) and latency (e.g., delay between the user speaking and the transcription) based on the ongoing development of deep neural networks. Neural network-based ASR models can unintentionally memorize specific parts about their training samples, thus being susceptible to privacy leakages about the potentially sensitive data they were trained on. Auditing the unintentional memorization of ASR models is critical to measure how vulnerable they are to various private information extraction attacks.

### SUMMARY

One aspect of the disclosure provides a computer-implemented method that when executed on data processing hardware causes the data processing hardware to perform operations that include receiving a training data set including un-transcribed speech utterances that each include audio-only data not paired with any corresponding transcription and obtaining a plurality of training canary transcriptions. Each training canary transcription includes a predetermined number of words that are out-of-distribution from words of the un-transcribed speech utterances. For each training canary transcription, the operations also include generating, using a text-to-speech (TTS) system, a corresponding synthetic training canary speech utterance that recites the predetermined number of words of the training canary transcription. The operations also include pre-training an audio encoder on a combination of the un-transcribed speech utterances and the synthetic training canary speech utterances. The operations also include measuring an un-intended memorization of the pre-trained audio encoder based on encoder labels predicted by the pre-trained encoder for the synthetic training canary speech utterances.

Implementations of the disclosure may include one or more of the following optional features. In some implementations, pre-training the audio encoder on the combination of the un-transcribed speech utterances and the synthetic training canary speech utterances includes, for each corresponding un-transcribed speech utterance and each synthetic training canary speech utterance: generating, at each of a plurality of output steps, using a random-projection quantizer, a target quantized vector token and a target token index for a corresponding audio feature in a sequence of audio features associated with the corresponding un-transcribed speech utterance or the corresponding synthetic training canary speech utterance, wherein the target token index maps the corresponding audio feature to the target quantized vector token stored in one or more codebooks; after masking a subset of the audio features in the sequence of audio features associated with the corresponding un-transcribed non-synthetic speech utterance, generating, by the audio encoder, contrastive context vectors from corresponding masked audio features; and deriving a contrastive loss term between the contrastive context vectors at the masked positions and the target token index, wherein the audio encoder is pre-trained based on the loss terms derived for each of the un-transcribed speech utterances and the synthetic training canary speech utterances. The operations may further include fine-tuning an automatic speech recognition model (ASR) on supervised training utterances. The ASR model may include the pre-trained audio encoder and a decoder.

In some examples, measuring the un-intended memorization of the pre-trained audio encoder includes: obtaining a plurality of unseen canary speech utterances, each unseen canary speech utterance including words that are out-of-distribution from the words of the un-transcribed speech utterances; and for each corresponding unseen canary speech utterance and each corresponding synthetic training canary speech utterance: generating, at each of a plurality of output steps, using a random-projection quantizer, a target quantized vector token and a target token index for a corresponding audio feature in a sequence of audio features associated with the corresponding unseen canary speech utterance or the corresponding synthetic training canary speech utterance, wherein the target token index maps the corresponding audio feature to the target quantized vector token stored in one or more codebooks; after applying a word-level mask masking a subset of the audio features in the sequence of audio features associated with a word in the corresponding unseen canary speech utterance or the corresponding synthetic training canary speech utterance, generating, by the audio encoder, contrastive context vectors from corresponding masked audio features, wherein the contrastive context vectors include the predicted encoder labels; and deriving a loss term between the contrastive context vectors at the masked word positions and the target token index, wherein measuring the unintended memorization of the pre-trained audio encoder is based on a comparison between the loss terms derived for the unseen canary speech utterances and the loss terms derived for the synthetic training canary speech utterances.

The operations may further include fine-tuning an automatic speech recognition model (ASR) on supervised training utterances. The ASR model may include the pre-trained audio encoder and a decoder.

In some implementations, obtaining the plurality of training canary transcriptions includes sampling, from a training text corpus, the top-N most frequent words that appear in the training text corpus and generating each training canary transcription by randomly selecting the predetermined number of words from the top-N most frequent words sampled from the training text corpus. In some additional implementations, obtaining the plurality of training canary transcriptions includes generating each training canary transcription by selecting a non-repeating permutation of digits. Additionally or alternatively, obtaining the plurality of training canary transcriptions may include sampling, from a non-native language text corpus, the top-N most frequent words that appear in the nonnative language text corpus and generating each training canary transcription by randomly selecting the predetermined number of words from the top-N most frequent words sampled from the non-native language text corpus. Optionally, obtaining the plurality of training canary transcriptions may include generating each training canary transcription as a non-verbal utterance.

In some examples, the operations also include applying sensitivity-bounded training when pre-training the audio encoder. Here, the sensitivity-bounded training may include per-example clipping wherein gradients of each example in a mini-batch is clipped before being averaged.

Another aspect of the disclosure provides a system that includes data processing hardware and memory hardware storing instructions that when executed on the data processing hardware causes the data processing hardware to perform operations. The operations include receiving a training data set including un-transcribed speech utterances that each include audio-only data not paired with any corresponding transcription and obtaining a plurality of training canary transcriptions. Each training canary transcription includes a predetermined number of words that are out-of-distribution from words of the un-transcribed speech utterances. For each training canary transcription, the operations also include generating, using a text-to-speech (TTS) system, a corresponding synthetic training canary speech utterance that recites the predetermined number of words of the training canary transcription. The operations also include pre-training an audio encoder on a combination of the un-transcribed speech utterances and the synthetic training canary speech utterances. The operations also include measuring an un-intended memorization of the pre-trained audio encoder based on encoder labels predicted by the pre-trained encoder for the synthetic training canary speech utterances.

This aspect of the disclosure may include one or more of the following optional features. In some implementations, pre-training the audio encoder on the combination of the un-transcribed speech utterances and the synthetic training canary speech utterances includes, for each corresponding un-transcribed speech utterance and each synthetic training canary speech utterance: generating, at each of a plurality of output steps, using a random-projection quantizer, a target quantized vector token and a target token index for a corresponding audio feature in a sequence of audio features associated with the corresponding un-transcribed speech utterance or the corresponding synthetic training canary speech utterance, wherein the target token index maps the corresponding audio feature to the target quantized vector token stored in one or more codebooks; after masking a subset of the audio features in the sequence of audio features associated with the corresponding un-transcribed non-synthetic speech utterance, generating, by the audio encoder, contrastive context vectors from corresponding masked audio features; and deriving a contrastive loss term between the contrastive context vectors at the masked positions and the target token index, wherein the audio encoder is pre-trained based on the loss terms derived for each of the un-transcribed speech utterances and the synthetic training canary speech utterances. The operations may further include fine-tuning an automatic speech recognition model (ASR) on supervised training utterances. The ASR model may include the pre-trained audio encoder and a decoder.

In some examples, measuring the un-intended memorization of the pre-trained audio encoder includes: obtaining a plurality of unseen canary speech utterances, each unseen canary speech utterance including words that are out-of-distribution from the words of the un-transcribed speech utterances; and for each corresponding unseen canary speech utterance and each corresponding synthetic training canary speech utterance: generating, at each of a plurality of output steps, using a random-projection quantizer, a target quantized vector token and a target token index for a corresponding audio feature in a sequence of audio features associated with the corresponding unseen canary speech utterance or the corresponding synthetic training canary speech utterance, wherein the target token index maps the corresponding audio feature to the target quantized vector token stored in one or more codebooks; after applying a word-level mask masking a subset of the audio features in the sequence of audio features associated with a word in the corresponding unseen canary speech utterance or the corresponding synthetic training canary speech utterance, generating, by the audio encoder, contrastive context vectors from corresponding masked audio features, wherein the contrastive context vectors include the predicted encoder labels; and deriving a loss term between the contrastive context vectors at the masked word positions and the target token index, wherein measuring the unintended memorization of the pre-trained audio encoder is based on a comparison between the loss terms derived for the unseen canary speech utterances and the loss terms derived for the synthetic training canary speech utterances.

The operations may further include fine-tuning an automatic speech recognition model (ASR) on supervised training utterances. The ASR model may include the pre-trained audio encoder and a decoder.

In some implementations, obtaining the plurality of training canary transcriptions includes sampling, from a training text corpus, the top-N most frequent words that appear in the training text corpus and generating each training canary transcription by randomly selecting the predetermined number of words from the top-N most frequent words sampled from the training text corpus. In some additional implementations, obtaining the plurality of training canary transcriptions includes generating each training canary transcription by selecting a non-repeating permutation of digits. Additionally or alternatively, obtaining the plurality of training canary transcriptions may include sampling, from a non-native language text corpus, the top-N most frequent words that appear in the nonnative language text corpus and generating each training canary transcription by randomly selecting the predetermined number of words from the top-N most frequent words sampled from the non-native language text corpus. Optionally, obtaining the plurality of training canary transcriptions may include generating each training canary transcription as a non-verbal utterance.

In some examples, the operations also include applying sensitivity-bounded training when pre-training the audio encoder. Here, the sensitivity-bounded training may include per-example clipping wherein gradients of each example in a mini-batch is clipped before being averaged.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example speech recognition system FIG. 2 is a schematic view of a Recurrent Neural Network-Transducer (RNN-T) model architecture.

FIG. 3 is a schematic view of an example pre-training process for pre-training an audio encoder.

FIG. 4 is a schematic view of an example process for generating training canary transcriptions.

FIG. 5 is an example auditing process for measuring unintended memorization by a pre-trained encoder.

FIGS. 6A and 6B are example plots depicting canary exposure based on a number of training steps (FIG. 6A) and a number of training repetitions (FIG. 6B.

FIG. 7 is a flowchart of an example arrangement of operations for pre-training an audio encoder using self-supervised learning and measuring unintended memorization of the pre-trained audio encoder.

FIG. 8 is a schematic view of an example computing device that may be used to implement the systems and methods described herein.

Like reference symbols in the various drawings indicate like elements.

### DETAILED DESCRIPTION

Machine learning models are capable of memorizing information contained in their training data. This is one of the reasons why models are vulnerable to privacy attacks such as membership inference and training data extraction. Resulting privacy concerns have led to a variety of techniques for private machine learning, including differentially private training, machine unlearning, and various heuristics like regularization, data augmentation or gradient clipping. These techniques all make modifications to the learning procedure so as to actively limit privacy leakage, including leakage that results from memorization. Training dynamics inherent to learning algorithms such as stochastic gradient descent may passively afford some forms of privacy. Such dynamics include forgetting: during iterative training, as models see new training examples, they could lose track of the specifics of earlier examples—as prominently seen by research on catastrophic forgetting.

Studying the impact of forgetting on privacy is most relevant when there is a large variation in how frequently an example may be seen during training. Indeed, models are increasingly trained on extremely large training sets, so that training consists of only a few epochs (or even a single one). Such settings are used when training large image models, multimodal models, and language models, the latter of which have come under significant scrutiny due to privacy concerns. Similarly, when a model is being fine-tuned, the data that was originally used to pretrain the model is no longer seen in the second stage of training. Fine tuning is also an ubiquitous technique in many domains, especially in language, speech, and vision tasks.

Popular ASR models are often released as modifiable checkpoints after being pre-trained on thousands of hours of crawled user-spoken utterances. Following this paradigm of pre-training ASR encoders on massive amount of data, especially web crawls that can contain sensitive information such as gender, dialect or identity of a speaker, can put the model at risk for leaking sensitive information.

There are multiple valid privacy guarantees that have been considered for machine learning algorithms. First, differential privacy ensures that the distribution of the output of the algorithm does not significantly change when a single example is changed. In the context of machine learning, differential privacy can be obtained through modifying either the training algorithm or the inference algorithm. Differential Privacy provably bounds the success of privacy attacks which leak information about individual training examples.

Differential Privacy is a way to combat the privacy leakage issue, by providing theoretical guarantees about the limits of influence of any individual training point towards the final model, thereby preventing an attacker from confidently inferring whether any particular sample was used for training. One challenge associated with DP training is the stringent privacy-utility-compute trade-offs for training large models. A straightforward technique to increase privacy is adding more noise, but that negatively affects the model performance or utility. One method to mitigate this is to increase batch size, but this comes at the cost of increasing compute which can be expensive.

Un-transcribed speech utterances have the potential to drastically limit the amount of labeled human speech required to train large ASR models, while also providing flexibility in moving the ASR model across different domain domains. Furthermore, un-transcribed speech utterances can be easily collected across a vast number of different languages since labeled (e.g., transcribed) speech utterances can be difficult to obtain for lower resource languages. As a result, self-supervised and/or semi-supervised training techniques can be applied to pre-train an audio encoder of a large ASR model on a large corpus of un-transcribed speech utterances to teach the audio encoder to learn general representations conveyed by the un-transcribed speech utterances. For instance, the audio encoder may be pre-trained on a set of un-transcribed speech utterances using Bidirectional Encoder Representations from Transformers (BERT)-based speech pre-training with random projection quantizer (BEST-RQ). Thereafter, the large ASR model may integrate the pre-trained audio encoder together with a speech decoder and a fine-tuning stage may adapt the large ASR model for downstream speech recognition tasks by fine-tuning the large ASR model on domain-specific datasets.

Privacy is an important consideration as these large ASR models are capable of memorizing outliers in fine-tuning datasets. Differential privacy refers to a system for sharing information from a dataset without revealing information about individuals from the dataset. That is, a user who receives differentially private information from a dataset ideally cannot infer any information about a single individual of the dataset. This allows, for example, the publication of demographic information while ensuring the privacy of individuals who provide the information. Differentially private (DP) machine learning is commonly used for training private models on private data. A trained DP model is trained to not reveal sensitive information from the private data used to train the DP model. That is, an observer of a DP model cannot infer from the predictions of the DP model whether data of a particular entity was used to train the model. Differentially private stochastic gradient descent (DP-SGD) has become a de facto standard algorithm for centralized training of DP models. However, naïve application of DP-SGD on large ASR models has shown to hinder model performance and incur higher computational costs which can be prohibitive for large ASR models whose training cost is already high.

Implementations herein are directed toward systematically auditing unintended memorization in the audio encoder after pre-training the audio encoder. Notably, implementations include pre-training the audio encoder on un-transcribed speech utterances that each include audio-only data not paired with any corresponding transcription and synthetic training speech utterances that each recite a predetermined number of words. Notably, each corresponding synthetic training canary speech utterance is generated by using a text-to-speech (TTS) system to perform TTS conversion on a corresponding training canary transcription that includes the predetermined number of words that are out-of-distribution from words of the un-transcribed speech utterances. As will become apparent, the auditing of unintended memorization reveals that the trained ASR encoder performs extremely well on recognizing the synthetic training canary speech utterances used to pre-train the ASR encoder but performs poorly on recognizing similar, but unseen, synthetic canary speech utterances that were not used to pre-train the ASR encoder. Implementations herein are further directed toward applying Differential Privacy training during self-supervised pre-training of the audio encoder by applying sensitivity-bounded training that includes application of per-example clipping by clipping gradients of each example in a mini-batch before averaging those gradients. Notably, the per-example gradient clipping technique applied during training bounds influence of each training sample and demonstrates its efficacy toward reducing memorization in the ASR encoder. Specifically, per-example gradient clipping may include clipping each training example's gradient to a fixed L2 normal bound if it is originally larger than the bound

The insertion of the synthetic training canary speech utterances that each recite the words that are out-of-distribution cannot be learned by the ASR encoder from the un-transcribed speech utterances reciting in-distribution words. The ASR encoder may be shown to exhibit unintended memorization fi the ASR encoder correctly predicts the inserted synthetic training canary speech utterances with high confidence. Due to the fundamentally different nature of ASR encoders that are pre-trained by self-supervised training, the synthetic training canary speech utterances must be carefully designed for successfully auditing unintended memorization of ASR encoders. Described in greater details below, implementations are directed toward generating four novel types of synthetic training canary speech utterances with different levels of out-of-distribution characteristics for insertion into the in-distribution non-synthetic speech utterances for pre-training the ASR encoder and applying a novel loss function that uses word-level masks tailored for self-supervised learning techniques such as BEST-RQ. Notably, this novel loss function that uses the word-level masks uncovers additional unintended memorization in the ASR encoder that cannot be uncovered using a conventional BEST-RQ loss that uses random masks.

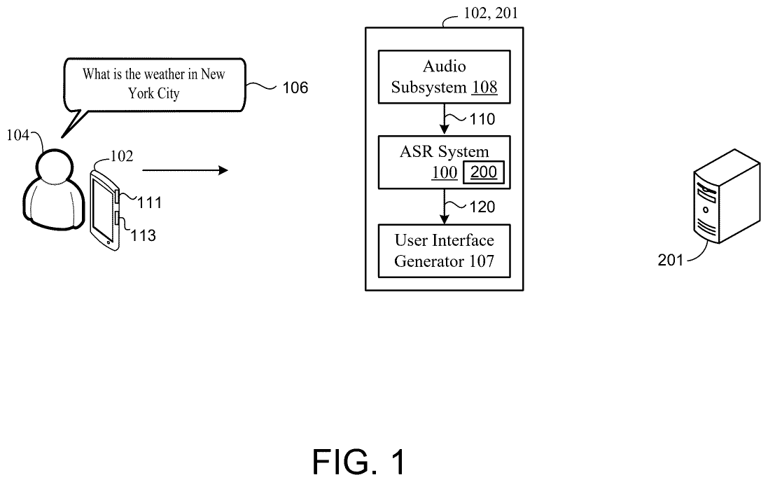

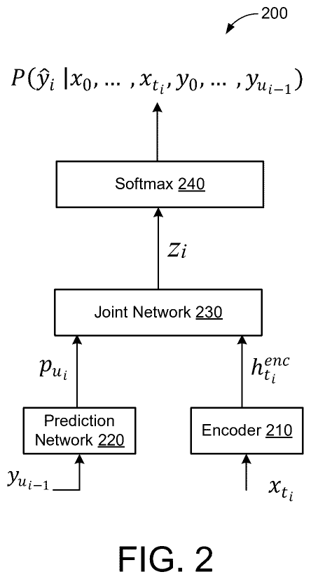

FIG. 1 illustrates an automated speech recognition (ASR) system 100 implementing an ASR model 200 that resides on a user device 102 of a user 104 and/or on a remote computing device 201 (e.g., one or more servers of a distributed system executing in a cloud-computing environment) in communication with the user device 102. Although the user device 102 is depicted as a mobile computing device (e.g., a smart phone), the user device 102 may correspond to any type of computing device such as, without limitation, a tablet device, a laptop/desktop computer, a wearable device, a digital assistant device, a smart speaker/display, a smart appliance, an automotive infotainment system, or an Internet-of-Things (IoT) device, and is equipped with data processing hardware 111 and memory hardware 113.

The user device 102 includes an audio subsystem 108 configured to receive an utterance 106 spoken by the user 104 (e.g., the user device 102 may include one or more microphones for recording the spoken utterance 106) and convert the utterance 106 into a corresponding digital format associated with input acoustic frames 110 capable of being processed by the ASR system 100. In the example shown, the user speaks a respective utterance 106 in a natural language of English for the phrase “What is the weather in New York City?” and the audio subsystem 108 converts the utterance 106 into corresponding acoustic frames 110 for input to the ASR system 100. Thereafter, the ASR model 200 receives, as input, the acoustic frames 110 corresponding to the utterance 106, and generates/predicts, as output, a corresponding transcription 120 (e.g., recognition result/hypothesis) of the utterance 106. In the example shown, the user device 102 and/or the remote computing device 201 also executes a user interface generator 107 configured to present a representation of the transcription 120 of the utterance 106 to the user 104 of the user device 102. In some configurations, the transcription 120 output from the ASR system 100 is processed, e.g., by a large language model or natural language understanding (NLU) module executing on the user device 102 or the remote computing device 201, to execute a user command. Additionally or alternatively, a text-to-speech system (e.g., executing on any combination of the user device 102 or the remote computing device 201) may convert the transcription into synthesized speech for audible output by another device. For instance, the original utterance 106 may correspond to a message the user 104 is sending to a friend in which the transcription 120 is converted to synthesized speech for audible output to the friend to listen to the message conveyed in the original utterance 106.

Referring to FIG. 2, an example frame alignment-based transducer model 200 includes a Recurrent Neural Network-Transducer (RNN-T) model architecture which adheres to latency constrains associated with interactive applications. The use of the RNN-T model architecture is exemplary, and the frame alignment-based transducer model 200 may include other architectures such as transformer-transducer and conformer-transducer model architectures among others. The RNN-T model 200 provides a small computational footprint and utilizes less memory requirements than conventional ASR architectures, making the RNN-T model architecture suitable for performing speech recognition entirely on the user device 102 (e.g., no communication with a remote server is required). The RNN-T model 200 includes an encoder network 210, a prediction network 220, and a joint network 230. The encoder network 210 (also referred to as ‘audio encoder’ 210), which is roughly analogous to an acoustic model (AM) in a traditional ASR system, includes a stack of multi-head attention layers (e.g., Conformer or Transformer layers) or a recurrent network of stacked Long Short-Term Memory (LSTM) layers. For instance, the encoder reads a sequence of d-dimensional feature vectors (e.g., acoustic frames 110 (FIG. 1)) x=(x₁, x₂, . . . , x_{T}), where xₜ∈R_{d}, and produces at each output step a higher-order feature representation. This higher-order feature representation is denoted as h₁^{enc}, . . . , h_{T}^{enc}.

Similarly, the prediction network 220 is also an LSTM network, which, like a language model (LM), processes the sequence of non-blank symbols output by a final Softmax layer 240 so far, y₀, . . . , yᵤᵢ₋₁, into a dense representation pᵤ_{ᵢ}. Finally, with the RNN-T model architecture, the representations produced by the encoder and prediction/decoder networks 210, 220 are combined by the joint network 230. The prediction network 220 may be replaced by an embedding look-up table to improve latency by outputting looked-up sparse embeddings in lieu of processing dense representations. The joint network then predicts P(yᵢ|xₜ, y₀, . . . , yᵤᵢ₋₁), which is a distribution over the next output symbol. Stated differently, the joint network 230 generates, at each output step (e.g., time step), a probability distribution over possible speech recognition hypotheses. Here, the “possible speech recognition hypotheses” correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the joint network 230 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces, phonemes, and/or entire words, in addition to or instead of graphemes. The output distribution of the joint network 230 can include a posterior probability value for each of the different output labels. Thus, if there are 100 different output labels representing different graphemes or other symbols, the output yᵢ of the joint network 230 can include 100 different probability values, one for each output label. The probability distribution can then be used to select and assign scores to candidate orthographic elements (e.g., graphemes, wordpieces, and/or words) in a beam search process (e.g., by the Softmax layer 240) for determining the transcription 120.

The Softmax layer 240 may employ any technique to select the output label/symbol with the highest probability in the distribution as the next output symbol predicted by the RNN-T model 200 at the corresponding output step. In this manner, the RNN-T model 200 does not make a conditional independence assumption, rather the prediction of each symbol is conditioned not only on the acoustics but also on the sequence of labels output so far. The RNN-T model 200 does assume an output symbol is independent of future acoustic frames 110, which allows the RNN-T model to be employed in a streaming fashion.

In some examples, the encoder network (i.e., audio encoder) 210 of the RNN-T model 200 includes a stack of multi-head attention layers/blocks, such as conformer blocks. Here, each conformer block includes a series of multi-headed self attention, depth wise convolution and feed-forward layers. The prediction network 220 may have two 2,048-dimensional LSTM layers, each of which is also followed by 640-dimensional projection layer. Alternatively, the prediction network 220 may include a stack of transformer or conformer blocks, or an embedding look-up table in lieu of LSTM layers. Finally, the joint network 230 may also have 640 hidden units. The Softmax layer 240 may be composed of a unified word piece or grapheme set that is generated using all unique word pieces or graphemes in a plurality of training data sets.

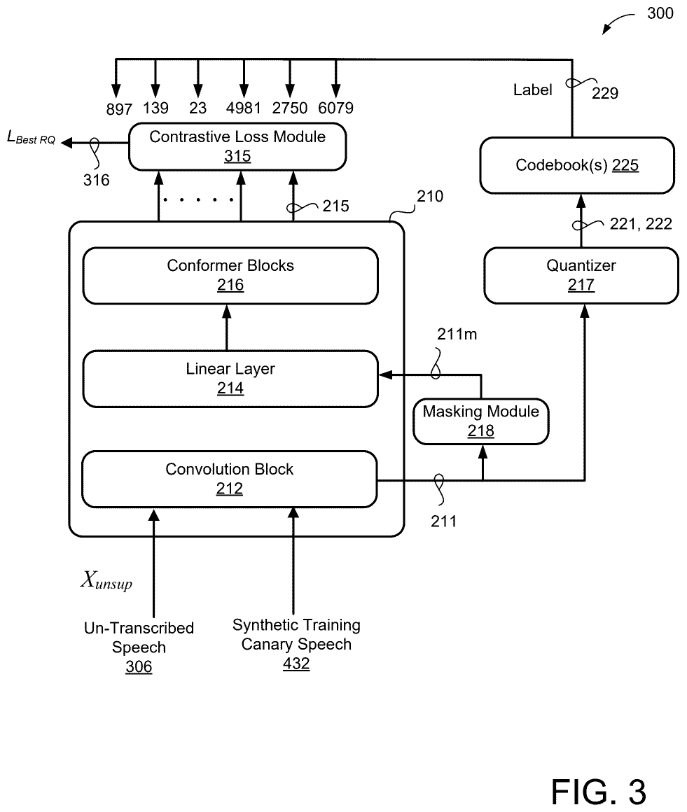

FIG. 3 illustrates an example pre-training process 300 for pre-training the audio encoder 210 of the ASR model 200 (FIGS. 1 and 2). The pre-training process may pre-train the audio encoder 210 on a combination of a plurality of un-transcribed non-synthetic speech utterances (Xᵤₙₛᵤₚ) 306 and a plurality of synthetic training canary speech utterances 332. Each un-transcribed non-synthetic speech utterance 306 (also referred to as simply “un-transcribed speech utterance 306”) may be obtained from a public training utterance set and include audio-only data (i.e., unpaired data) such that the un-transcribed speech utterance 306 is not paired with any corresponding transcription. In some examples, the plurality of un-transcribed speech utterances 306 include utterances spoken in a single language (e.g, English). On the other hand, each corresponding synthetic training canary speech utterance 332 recites a predetermined number of words that are out-of-distribution from words of the un-transcribed speech utterances. In some examples, the predetermined number of words recited by each synthetic training canary speech utterance 332 is equal to ten (10) words. In other examples, the predetermined number of words may be less than ten (10) words or greater than ten (10) words without departing from the scope of the present disclosure.

The pre-training process 300 may insert the synthetic training canary speech utterances 332 with a different number of repetitions {1, 2, 4, 6, 8, 16} into the plurality of un-transcribed non-synthetic speech utterances 306 for pre-training the audio encoder 210. In some examples, the pre-training process 300 uses ‘30’ unique synthetic training canary speech utterances 332 for each of the repetitions.

The pre-training process 300 pre-trains the audio encoder 210 on a contrastive losses (L_{w2v}) 316 derived from the combination of the un-transcribed non-synthetic speech utterances (Xᵤₙₛᵤₚ) 306 and the synthetic training canary speech utterances 332. The audio encoder 210 includes incudes a plurality of multi-head attention blocks (interchangeably referred to as ‘multi-head attention layers’). For instance, the audio encoder 210 may include Conformer encoder including a stack of conformer blocks each of which includes a series of multi-headed self attention, depth wise convolution, and feed-forward layers. Alternatively, the audio encoder 210 may include another type of encoder having a stack of multi-head attention layers/blocks, such as a transformer encoder. For simplicity, the audio encoder 210 will be referred to as a Conformer encoder 210. The Conformer encoder 210 can naturally be split into a feature encoder, including a convolution subsampling block 212, and a context network, including a linear layer 214 and a stack of Conformer blocks 216. In some implementations, the convolution subsampling block 212 has two two-dimensional-convolution layers, both with strides (2, 2), resulting in a 4× reduction in the feature sequence length. The convolution subsampling block 212 receives, as input, a sequence of input features/vectors (e.g., mel-frequency spectrograms such as the acoustic frames 110 of FIG. 1) associated with each corresponding un-transcribed non-synthetic speech utterance 306 and each corresponding synthetic training canary speech utterance, and generates, as output, for each of a plurality of output steps, an encoded audio feature 211 that corresponds to a respective one of the un-transcribed non-synthetic speech utterances 306 or the synthetic training canary speech utterances 332.

The encoded audio features 211 (i.e., interchangeably referred to as “encoded features 211”) output from the convolution subsampling block 212 may be fed to a masking module 218 where some of the encoded features 211 are randomly chosen and replaced with a trained feature vector shared between all masked time steps to provide corresponding masked encoded audio features 211, 211m. In some examples, the masking module 218 masks the randomly chosen encoded features 211 for masking by randomly sampling without replacement a certain proportion p of all time steps to be start indices and then masks the subsequent M consecutive time steps from every sample index, whereby some spans may overlap. After masking is applied, the linear layer 214 and the Conformer blocks 216 of the context network receives the masked encoded features 211m (or encoded features 211 not chosen by the masking module 218) and outputs corresponding contrastive context vectors (i.e., encoded representation) 215 from masked encoded features 211m.

Moreover, a quantizer 217 receives the encoded features 211 as input, and applies random projections to generate, at each of the plurality of output steps, a target quantized vector token 221 and a target token index 222 for a corresponding encoded feature 211 as output. As such, the quantizer 217 generates the target quantized vector token 221 and the target token index 222 using the encoded representations 211 that do not include any masking. Here, the quantizer 217 generates the target quantized vector tokens 221 according to qᵢ∈{eⱼ}ⱼ₌₁^{V}. The quantizer 217 summarizes all of the encoded features 211, 213 into representative target quantized vector tokens (i.e., discriminative speech tokens) 221. The representative target quantized vector tokens 221 generated by the quantizer 217 represent a finite set of representative target quantized vector tokens referred to as a codebook 225. The target token index 222 maps each corresponding encoded feature 211 to a respective one of the target quantized vector tokens 221 stored in the codebook 225. In some implementations, the quantizer 217 projects the target context vector 221 to a randomly initialized codebook 225 that maps the target context vectors 221 to discrete labels 229 by finding a nearest vector in the codebook 225. Here, the target context vector 221 collectively refers to the target quantized vector tokens 221 and the target token index 222. Notably, the quantizer 217 includes a random-projection quantizer 217 configured to randomly initialize a matrix and the codebook 225. The random-projection quantizer 217 uses the matrix to project the encoded features 211 into the target context vectors 221 and uses the codebook 225 to find a nearest vector where an index of the vector includes the label 229. In some examples, the codebook 225 finds the nearest vector by determining a cosine similarity as a distance measurement.

Thereafter, a contrastive loss module 315 derives a contrastive loss term (L_{Best RQ}) 316 between the contrastive context vectors 215 at the masked positions and the target context vectors 221 as follows.

$$L = - log \frac{exp ( sim ( {c}_{t} , {q}_{t} ) / k )}{{\sum }_{\tilde{q} ∼ {Q}_{t}} exp ( sim ( {c}_{t} , \tilde{q} ) / k )} \qquad ( 1 )$$

where cₜ is contrastive context vector 215 centered over a masked time step t and qₜ represents a target context vector 221 at the time step t in a set of K+1 candidate target context vectors 221 which includes qₜ and K distractors. Distractors may be uniformly sampled from other masked time steps of the same utterance. Advantageously, the contrastive loss 316 represents a Bidirectional Encoder Representations from Transformers (BERT)-based Speech pre-Training with Random Projection Quantizer (BEST-RQ) loss does not require an additional quantization module that other contrastive losses (e.g., w2v-BERT) require. As such, since the BEST-RQ loss does not require the additional quantization module, the BEST-RQ loss enables the ASR model 200 to be more scalable for multiple languages during pre-training.

The contrastive loss 316 is optimized between the contrastive context vectors 215 at the masked positions and the target context vectors 221. Thus, the contrastive loss 316 may be optimized for real/human (non-synthetic) utterances that are publicly-available, and thus, there are no privacy concerns with using the un-transcribed speech utterances 306 for pre-training the audio encoder 210. Accordingly, the pre-training process 300 pre-trains the audio encoder 210 on the derived contrastive loss 316 applied on the corresponding encoded features 211 associated with each un-transcribed non-synthetic speech utterance 306 and each synthetic training canary speech utterance 332 provided as input to the audio encoder 210. Pre-training the audio encoder 210 may include updating parameters of the audio encoder 210 based on the contrastive losses 316.

In some implementations, the pre-training process 300 uses one or more codebooks 225 instead of using a single codebook 225. For example, the pre-training process 300 may use sixteen (16) codebooks 225. More specifically, the audio encoder 210 generates N number of contrastive context vectors 215 (e.g., probability predictions output from the audio encoder 210) using a corresponding N number of softmax output layers for each encoded feature 211. This is in contrast to generating a single contrastive context vector 215 for each encoded feature 211 using a single codebook 225. To that end, the pre-training process 300 randomly initializes N number of different codebooks 225 and, using each respective codebook 225 of the N number of codebooks 225, to finds a respective nearest vector where an index of the vector includes the corresponding label 229 of the respective codebook 225. By using multiple codebooks 225, the pre-training process 300 compares N number of contrastive context vectors 215 to a corresponding N number of labels 229 for each encoded feature 211. Advantageously, using multiple codebooks 225 enables the pre-training process 300 to improve stability and convergence of the audio encoder 210 during pre-training. In some examples, the pre-training process 300 pre-trains the audio encoder 210 using equal weights for each softmax layer output of the audio encoder 210.

Differentially private (DP)-stochastic gradient descent (SGD) training is a proven way to mitigate unintended memorization of training data. However, DP-SGD is well-known to significantly reduce utility of the resulting trained model. This is especially true of large models, such as audio encoders trained by the BEST-RQ pre-training process 300, whereby due to the curse of dimensionality, the noise that DP-SGD adds during training can completely destroy utility of these audio encoders. To combat these drawbacks of using DP-SGD, implementations herein are directed toward the pre-training process 300 applying sensitivity-bounded training when pre-training the audio encoder 210. Specifically, the training process 300 may apply sensitivity-bounded training that includes per-example gradient clipping wherein gradients of each training sample in a mini-batch are clipped before being averaged. Such per-example gradient clipping reduces memorization by the audio encoder since per-example gradient clipping prevents a ny training sample from having an out-sized impact on the pre-training, and hence, the resulting pre-trained audio encoder 210. Furthermore, to achieve stronger DP guarantees that provably mitigate memorization, the DP training clips per-example gradients and adds carefully calibrated noise to them. Stated differently, the per-example clipping directs the pre-training toward achieving strong DP guarantees which is a key advantage over ad-hoc privacy-preserving training objectives.

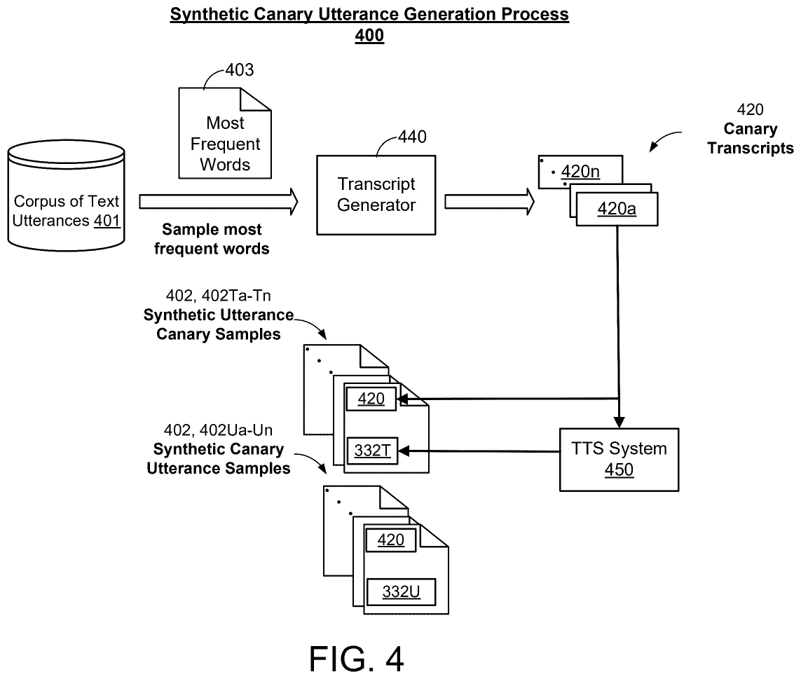

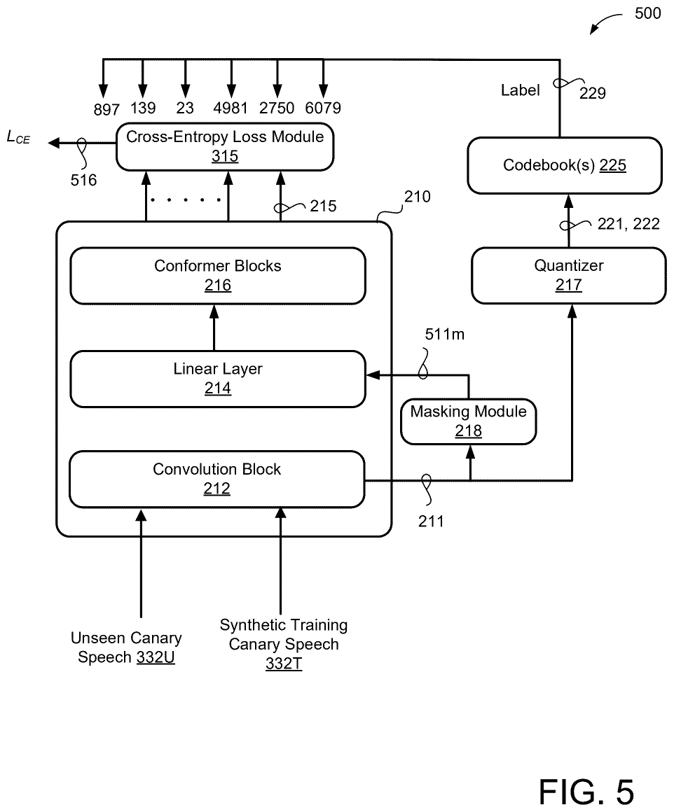

Referring to FIG. 4, a synthetic canary utterance generation process 400 may generate the synthetic canary utterance samples 402 used during both the pre-training process 300 (FIG. 3) for pre-training the audio encoder 210 and an auditing process 500 (FIG. 5) for measuring un-intended memorization of the pre-trained audio encoder 210. Ultimately, the synthetic canary utterance generation process 400 may generate a first set of synthetic canary utterance samples 402T, 402Ta-Tn that each include a corresponding synthetic training canary speech utterance 332, 332T used by the pre-training process 300 in combination with the un-transcribed speech utterances 308 for pre-training the audio encoder 210 as discussed above with reference to FIG. 3 and a second set of synthetic canary utterance samples 402U, 402Ua-Un that each include a corresponding synthetic unseen canary speech utterance 332, 332U used by the auditing process 500 in combination with the synthetic training canary speech utterances 332T for measuring the un-intended memorization of the pre-trained audio encoder. For clarity, the only distinction between the first and second sets of synthetic canary utterance samples 402T, 402U is that the synthetic training canary speech utterances 332T associated with the first set of synthetic canary utterance samples 402T are used to pre-train the audio encoder 210 while the synthetic unseen canary speech utterances 332U associated with the second set of s synthetic canary utterance samples 402U are not seen by or used to pre-train the audio encoder 210 during the pre-training process.

Initially, the synthetic canary utterance generation process 400 samples a top-N most frequent words 403 that appear in a corpus of text utterances 401. The corpus of text utterances 401 may include text-only utterances that are not paired with any corresponding audio/speech representation of the utterances. In some examples, the process 400 samples the 10,000 most frequent words 403 that appear in the corpus of text utterances 401. Thereafter, the process 400 employs a transcript generator that receives the top-N most frequent words 403 that appear in the corpus of text utterances 401 and randomly generates a plurality of canary transcripts 420, 420a-n. Here, each canary transcript 420 is generated by randomly selecting the predetermined number of words (e.g., 10 words) from the top-N most frequent words sampled from the training text corpus. For instance, each transcript 420 generated by the transcript generator may include ten words randomly sampled from the top-N (e.g., 10,000) most frequent words 403. The transcript generator 440 may randomly sample less than ten words or more than ten words from the most frequent words 503 when generating each canary transcript 420 without departing from the scope of the present disclosure. Ideally, the same number of words included in each canary transcript 420 and randomly sampled from the most frequent words 403 may be chosen such that the canary transcripts 420 include a sufficient word length that captures short natural phrases while still allowing substantially linguistic variety across the predetermined number of most frequent words 403.

Finally, the synthetic training sample generation process 400 provides, as input, each corresponding transcript 420 having the same number of words randomly sampled from the most frequent words 403 to a text-to-speech (TTS) system 450 that converts the corresponding transcript 420a into a corresponding synthesized speech utterance 332. For instance, for a first transcript 420a the TTS system 450 generates a corresponding first synthesized speech utterance 432 that characterizes the number of words included in the first transcript 420a in a synthetic voice. Each corresponding transcript 420 and the corresponding synthetic speech utterance 332 form a corresponding synthetic training sample 402. Accordingly, the synthetic canary utterance generation process 400 generates the first and second sets of synthetic canary utterance samples 402 that each include a corresponding one of the canary transcripts 420 generated by the transcript generator 440 and the corresponding synthetic speech utterance 332T, 332U output from the TTS system 450. In some scenarios, the TTS system 450 may receive other inputs such speaker embeddings to produce synthesized speech utterances 332 in different voices, as well as style, prosody, and/or accent embeddings to produce synthesized speech utterances 404 with different styles, prosodies, and/or accents.

The synthetic canary utterance generation process 400 may sample the top-N most frequent words that appear in a corpus of text utterances 401 that include text utterances in a same language as the un-transcribed speech utterances 308 (FIG. 3) but with words that are out-of-distribution from the words of the un-transcribed speech utterances. For instance, the resulting synthetic canary utterance samples 402 and un-transcribed speech utterances 308 may both be in the English language. In this scenario, the synthetic canary utterance samples 402 may include a first type of canary utterance samples for training and auditing the audio encoder.

Additionally or alternatively, synthetic canary utterance generation process 400 may sample the top-N most frequent words that appear in a corpus of text utterances 401 that include text utterances in a different language than the un-transcribed speech utterances 308 (FIG. 3) such that the top-N most frequent words are out-of-distribution from the un-transcribed speech utterances. For instance, the resulting synthetic canary utterance samples 402 may be in Afrikaans while the un-transcribed speech utterances 308 may be in English. In these examples, the TTS system 450 may generate the synthesized speech utterances 332 in a voice of a speaker who speaks the same language as the language (e.g., Afrikaans) of the resulting synthetic canary utterance samples 402 In this scenario, the synthetic canary utterance samples 402 may include a second type of canary utterance samples for training and auditing the audio encoder.

In some additional implementations, the transcript generator 440 generates canary transcripts 420 that each include the predetermined number of words formed by selecting a non-repeating premutation of random digits. Here, each random digit corresponds to one of the predetermined number of words in the canary transcription 420. In some examples, each random digit is in the same language as the un-transcribed speech utterances 308. For instance, the random digits may include non-repeating English digits such that each canary transcription 420 is a permutation of the predetermined number (e.g., 10) digits. In these examples, the TTS system 450 may generate the synthesized speech utterances 332 in a voice of a speaker who speaks the same language as the language of the un-transcribed speech utterances 308. In this scenario, the synthetic utterance canary samples 402 may include a third type of canary utterance samples for training and auditing the audio encoder 210.

In further implementations, the process 400 generates a fourth type of canary utterance samples 402 for training and auditing the audio encoder 210. Here, the transcript generator 440 generates non-verbal canary transcripts 420 that are completely out-of-distribution with respect to the words contained in the un-transcribed speech utterances 308. The TTS system 450 may then generate the synthesized speech utterances 332 from the non-verbal canary transcripts to produce the fourth type of canary utterance samples 402 that each correspond to random noise. The need for a canary transcript 420 could be bypassed in some scenarios where the random noise associated with the fourth type of canary utterance samples 402 may simply include music or some other sound or noise.

The pre-training process 300 for pre-training the audio encoder 210 and the auditing process 500 for measuring unintended memorization of the pre-trained audio encoder 210 may use any combination of the four different types of synthetic canary utterance samples 402 generated by the synthetic canary utterance generation process 400. Notably, each of the four different types of synthetic canary utterance samples are designed to be useful for auditing audio encoders pre-trained using self-supervised pre-training techniques, such as BERT-RQ, wherein the synthetic canary utterance samples 402 are out-of-distribution with respect to the un-transcribed speech utterances 308. The intuition is that unsupervised training will minimize cross-entropy loss on synthetic training canary speech utterances 332T used for pre-training the audio encoder 210, thereby strongly memorizing the training canary speech utterances 332T, while the audio encoder will not generalize well on the similar unseen canary speech utterances 332U due to lack of similar out-of-distribution data seen in training, thereby resulting in poor performance on the unseen canary speech utterances 332U. As will become apparent with respect to the auditing process 500 of FIG. 5, if the difference between the unseen canary speech utterances 332U and the training canary speech utterances 332T of the same type is significant, a correlation that the audio encoder 210 unintentionally memorized the training canary speech utterances 332 will be revealed.

FIG. 5 illustrates an example auditing process 500 for measuring unintended memorization of the pre-trained audio encoder 210 (e.g., after pre-training the audio encoder 300 using pre-training process 300 of FIG. 3). The auditing process 500 measures un-intended memorization of the pre-trained audio encoder 210 based on a comparison between cross-entropy terms 516 derived for the unseen canary speech utterances 332U and cross-entropy terms derived for the training canary speech utterances 332T. As discussed above with reference to FIG. 3, the training canary speech utterances 332T were used by the pre-training process 300 in combination with the un-transcribed speech utterances 308 for pre-training the audio encoder 210 while the unseen canary speech utterances 332U have not been seen or processed by the audio encoder 210 prior to the auditing process 500. Whereas the pre-training process 300 applies random masks 211m for masking audio features, the auditing process 500 instead applies word-level masks 511m for masking a subset of the audio features associated with a word in each corresponding unseen canary speech utterance 332U or training canary speech utterance 332T.

The pre-trained audio encoder 210 includes incudes the plurality of multi-head attention blocks, such as the Conformer encoder including a stack of conformer blocks each of which includes a series of multi-headed self attention, depth wise convolution, and feed-forward layers. Alternatively, the audio encoder 210 may include another type of encoder having a stack of multi-head attention layers/blocks, such as a transformer encoder. For simplicity, the pre-trained audio encoder 210 will be referred to as the Conformer encoder 210. The Conformer encoder 210 can naturally be split into the feature encoder, including a convolution subsampling block 212, and the context network, including the linear layer 214 and the stack of Conformer blocks 216. In some implementations, the convolution subsampling block 212 has two two-dimensional-convolution layers, both with strides (2, 2), resulting in a 4× reduction in the feature sequence length. The convolution subsampling block 212 receives, as input, a sequence of input features/vectors (e.g., mel-frequency spectrograms such as the acoustic frames 110 of FIG. 1) associated with each corresponding unseen canary speech utterance 332U and each corresponding synthetic training canary speech utterance 332T, and generates, as output, for each of a plurality of output steps, an encoded audio feature 211 that corresponds to a respective one of the unseen canary speech utterance 332U or the synthetic training canary speech utterances 332T.

The encoded audio features 211 (i.e., interchangeably referred to as “encoded features 211”) output from the convolution subsampling block 212 may be fed to a masking module 218 where a subset of the encoded features 211 associated with a word in the corresponding unseen canary speech utterance 332U or the corresponding synthetic training canary speech utterances 332T are chosen and replaced with a trained feature vector shared between all masked time steps to provide corresponding word-level masked encoded audio features 511m. Here, instead of the masking module 218 masking randomly chosen encoded features 211 for masking by randomly sampling without replacement a certain proportion p of all time steps to be start indices and then masks the subsequent M consecutive time steps from every sample index as during the pre-training process 300, the masking module 218 instead masks the encoded audio features 211 for the word in the corresponding unseen canary speech utterance 332U or the corresponding synthetic training canary speech utterances 332T such that the duration of audio characterizing the word is completely masked. After the word-level masking is applied, the linear layer 214 and the Conformer blocks 216 of the context network receives the masked word-level encoded features 511m for the masked word (or encoded features 211 not chosen by the masking module 218) and outputs corresponding contrastive context vectors (i.e., encoded representation) 215 from masked word-level encoded features 511m.

Moreover, the quantizer 217 receives the encoded features 211 as input, and applies random projections to generate, at each of the plurality of output steps, a target quantized vector token 221 and a target token index 222 for a corresponding encoded audio feature 211 as output. As such, the quantizer 217 generates the target quantized vector token 221 and the target token index 222 using the encoded representations 211 that do not include any masking. Here, the quantizer 217 generates the target quantized vector tokens 221 according to qᵢ∈{eⱼ}ⱼ₌₁^{V}. The quantizer 217 summarizes all of the encoded audio features 211 into representative target quantized vector tokens (i.e., discriminative speech tokens) 221. The representative target quantized vector tokens 221 generated by the quantizer 217 represent a finite set of representative target quantized vector tokens referred to as a codebook 225. The target token index 222 maps each corresponding encoded feature 211 to a respective one of the target quantized vector tokens 221 stored in the codebook 225. In some implementations, the quantizer 217 projects the target context vector 221 to a randomly initialized codebook 225 that maps the target context vectors 221 to discrete labels 229 by finding a nearest vector in the codebook 225. Here, the target context vector 221 collectively refers to the target quantized vector tokens 221 and the target token index 222. Notably, the quantizer 217 includes a random-projection quantizer 217 configured to randomly initialize a matrix and the codebook 225. The random-projection quantizer 217 uses the matrix to project the encoded features 211 into the target context vectors 221 and uses the codebook 225 to find a nearest vector where an index of the vector includes the label 229. In some examples, the codebook 225 finds the nearest vector by determining a cosine similarity as a distance measurement.

Thereafter, a cross-entropy loss module 515 derives a cross-entropy loss term (L_{CE}) 516 for each encoded feature 211 (e.g, predicted encoder label) by comparing the corresponding contrastive context vector 215 at the word-level masked position 511m and the corresponding target context vector 221. Notably, application of random masks as used during the pre-training process 300 provide strong context to the audio encoder 210 about the word they partially mask, whereby such additional context can lead to underestimation of exposure of canary speech utterances. Given the partial masking issue with random masks, the auditing process 500 uses the word-level masks instead to improve auditing because word-level masks mask each word completely, and therefore, do not give any partial context when the audio encoder 210 predicts the masked word. Hence, only if the audio encoder has memorized an entire training canary utterance, can the pre-trained audio encoder predict the masked words with high confidence during training. Accordingly, using word-level masks to compute cross-entropy loss terms 516 provides better differentiation between performance of the pre-trained audio encoder on training canary speech utterances 332T and unseen canary speech utterances 332U.

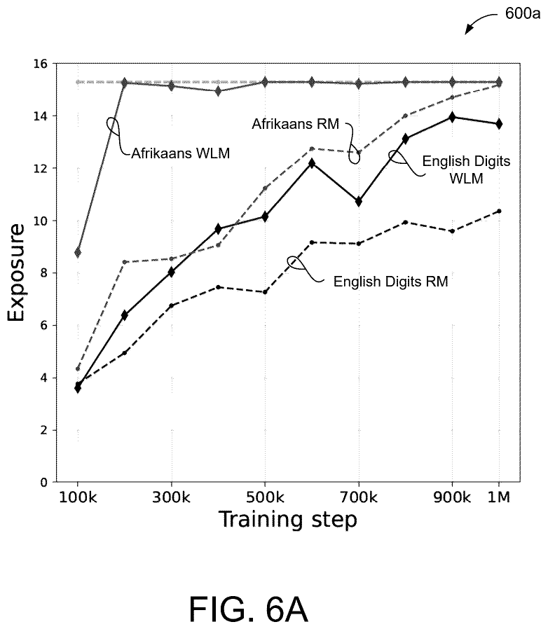

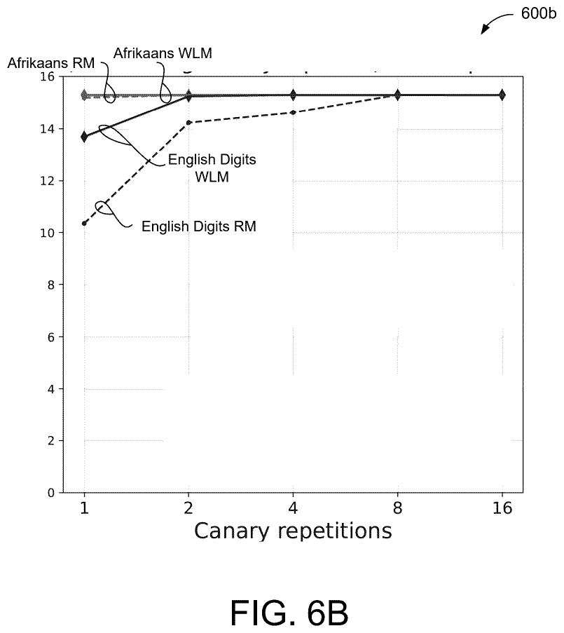

FIGS. 6A and 6B show example plots 600a, 600b comparing application of random masks and word-level masks to compute exposures of the canary speech utterances 332U, 332T by the pre-trained audio encoder. The canary speech utterances 332U, 332T used for comparison include the second type of canary utterance samples that include synthesized speech utterances 332 spoken in the language of Afrikaans and the third type of canary utterance samples that include synthesized speech utterances 332 of non-repeating permutations of English digits. The y-axis for each of the plots 600a, 600b denotes a number of exposures for each of Afrikaans canary speech utterances (Afrikaans RM) when random masks are applied by the auditing process 500, Afrikaans canary speech utterances (Afrikaans WLM) when word-level masks are applied by the auditing process 500, non-repeating English digits canary speech utterances (English Digits RM) when random masks are applied by the auditing process 500, and non-repeating English digits canary speech utterances (English Digits WLM) when word-level masks are applied by the auditing process 500.

Referring to the plot 600a of FIG. 6A, the x-axis denotes a number of training steps of the pre-training process 300 of FIG. 3A. Notably, the number of exposures for all the canary speech utterances increases as the number of training steps increases. Here, the synthesized training canary speech utterances 332T only occur once during the pre-training process 300. Notably, the plot 600a reveals a clear increase in exposures when using word-level masks to compute the cross-entropy losses on canary speech utterances, thereby implying that word-level masks improve detection of unintended memorization by the pre-trained audio encoder 210 that application of random masks fails to detect during early training steps. For instance, using word-level masks, the distinction between the training and seen canary speech utterances in Afrikaans becomes evident as soon as the 100 k^{th} training step, while an upper bound is reached at just the 200 k^{th} training step.

Referring to the plot 600b of FIG. 6B, the x-axis denotes a number of repetitions of the synthetic training canary speech utterances 332T used in the pre-training process 300 at the 1 millionth training step. Notably, the canary speech utterances in Afrikaans are completely memorized even if they occur just once during training. Even for the canary speech utterances of non-repeating English Digits, the English Digits WLM show that the pre-trained audio encoder 210 can completely memorize these canary speech utterances even if they repeat only two times during the pre-training process 300.

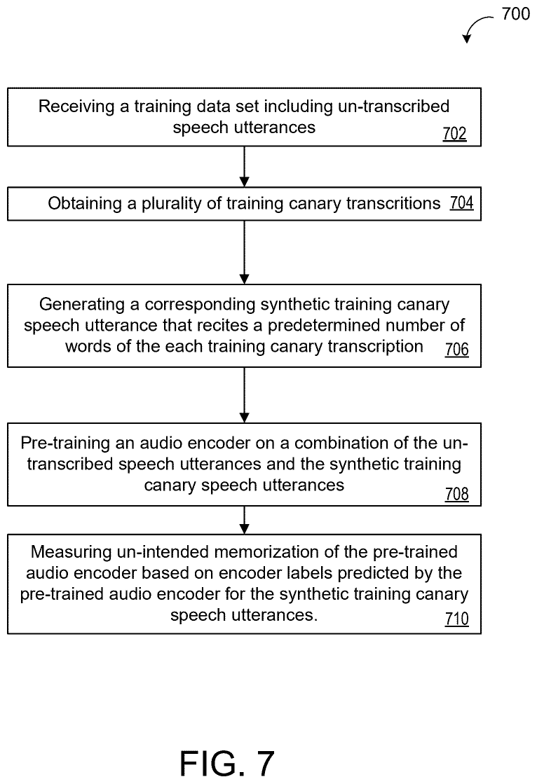

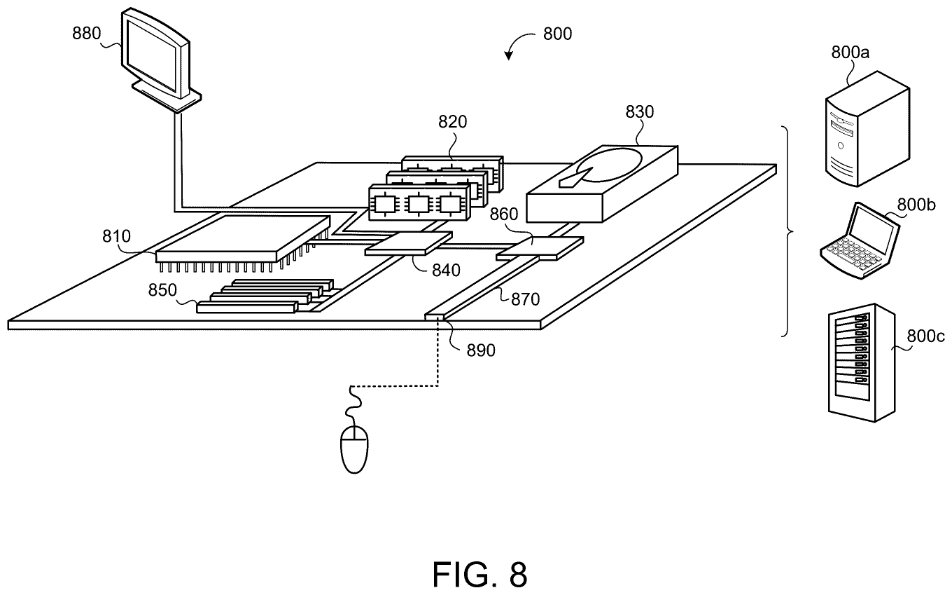

FIG. 7 is a flowchart of an example arrangement of operations for a computer-implemented method 700 of pre-training an audio encoder using self-supervised learning and performing auditing to measure un-intended memorization of the pre-trained audio encoder. The method 700 may execute on data processing hardware 810 (FIG. 8) using instructions stored on memory hardware 820 (FIG. 8). The data processing hardware 810 and the memory hardware 820 may reside on the remote computer/server 201 and/or the user device 102 of FIG. 1 each corresponding to a computing device 800 (FIG. 8).

At operation 702, the method 700 includes receiving a training data set that includes un-transcribed speech utterances 308 that each include audio-only data not paired with any corresponding transcription. At operation 704, the method 700 includes obtaining a plurality of canary transcriptions 420 that each include a predetermined number of words that are out-of-distribution from words of the un-transcribed speech utterances 308.

At operation 706, for each training canary transcription 420, the method 700 includes generating, using a text-to-speech (TTS) system 440, a corresponding synthetic training canary speech utterance 332T that recites the predetermined number of words of the training canary transcription 420. At operation 708, the method 700 includes pre-training the audio encoder 210 on a combination of the un-transcribed speech utterances 308 and the synthetic training canary speech utterances 332T. At operation 710, the method 700 includes measuring an un-intended memorization of the pre-trained audio encoder 210 based on encoder labels 211 predicted by the pre-trained encoder 210 for the synthetic training canary speech utterances 332T.

FIG. 8 is a schematic view of an example computing device 800 that may be used to implement the systems and methods described in this document. The computing device 800 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 800 includes a processor 810, memory 820, a storage device 830, a high-speed interface/controller 840 connecting to the memory 820 and high-speed expansion ports 850, and a low speed interface/controller 860 connecting to a low speed bus 870 and a storage device 830. Each of the components 810, 820, 830, 840, 850, and 860, are interconnected using various busses, and may be mounted on a common motherboard or in other manners as appropriate. The processor 810 can process instructions for execution within the computing device 800, including instructions stored in the memory 820 or on the storage device 830 to display graphical information for a graphical user interface (GUI) on an external input/output device, such as display 880 coupled to high speed interface 840. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 820 stores information non-transitorily within the computing device 800. The memory 820 may be a computer-readable medium, a volatile memory unit(s), or non-volatile memory unit(s). The non-transitory memory 820 may be physical devices used to store programs (e.g., sequences of instructions) or data (e.g., program state information) on a temporary or permanent basis for use by the computing device 800. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 830 is capable of providing mass storage for the computing device 800. In some implementations, the storage device 830 is a computer-readable medium. In various different implementations, the storage device 830 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 820, the storage device 830, or memory on processor 810.

The high speed controller 840 manages bandwidth-intensive operations for the computing device 800, while the low speed controller 860 manages lower bandwidth-intensive operations. Such allocation of duties is exemplary only. In some implementations, the high-speed controller 840 is coupled to the memory 820, the display 880 (e.g., through a graphics processor or accelerator), and to the high-speed expansion ports 850, which may accept various expansion cards (not shown). In some implementations, the low-speed controller 860 is coupled to the storage device 830 and a low-speed expansion port 890. The low-speed expansion port 890, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 800a or multiple times in a group of such servers 800a, as a laptop computer 800b, or as part of a rack server system 800c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
receiving a training data set comprising un-transcribed speech utterances that each comprise audio-only data not paired with any corresponding transcription;
obtaining a plurality of training canary transcriptions, each training canary transcription comprising a predetermined number of words that are out-of-distribution from words of the un-transcribed speech utterances;
for each training canary transcription, generating, using a text-to-speech (TTS) system, a corresponding synthetic training canary speech utterance that recites the predetermined number of words of the training canary transcription;
pre-training an audio encoder on a combination of the un-transcribed speech utterances and the synthetic training canary speech utterances; and
measuring an un-intended memorization of the pre-trained audio encoder based on encoder labels predicted by the pre-trained audio encoder for the synthetic training canary speech utterances.

2. The method of claim 1, wherein pre-training the audio encoder on the combination of the un-transcribed speech utterances and the synthetic training canary speech utterances comprises:
for each corresponding un-transcribed speech utterance and each synthetic training canary speech utterance:
generating, at each of a plurality of output steps, using a random-projection quantizer, a target quantized vector token and a target token index for a corresponding audio feature in a sequence of audio features associated with the corresponding un-transcribed speech utterance or the corresponding synthetic training canary speech utterance, wherein the target token index maps the corresponding audio feature to the target quantized vector token stored in one or more codebooks;
after masking a subset of the audio features in the sequence of audio features associated with the corresponding un-transcribed non-synthetic speech utterance or the corresponding synthetic training canary speech utterance, generating, by the audio encoder, contrastive context vectors from corresponding masked audio features; and
deriving a loss term between the contrastive context vectors at the masked positions and the target token index; and
pre-training the audio encoder based on the loss terms derived for each of the un-transcribed speech utterances and the synthetic training canary speech utterances.

3. The method of claim 1, wherein measuring the un-intended memorization of the pre-trained audio encoder comprises:
obtaining a plurality of unseen canary speech utterances, each unseen canary speech utterance comprising words that are out-of-distribution from the words of the un-transcribed speech utterances;
for each corresponding unseen canary speech utterance and each corresponding synthetic training canary speech utterance:
generating, at each of a plurality of output steps, using a random-projection quantizer, a target quantized vector token and a target token index for a corresponding audio feature in a sequence of audio features associated with the corresponding unseen canary speech utterance or the corresponding synthetic training canary speech utterance, wherein the target token index maps the corresponding audio feature to the target quantized vector token stored in one or more codebooks;
after applying a word-level mask masking a subset of the audio features in the sequence of audio features associated with a word in the corresponding unseen canary speech utterance or the corresponding synthetic training canary speech utterance, generating, by the audio encoder, contrastive context vectors from corresponding masked audio features, wherein the contrastive context vectors comprise the predicted encoder labels; and
deriving a loss term between the contrastive context vectors at the masked word positions and the target token index; and
measuring the un-intended memorization of the pre-trained audio encoder based on a comparison between the loss terms derived for the unseen canary speech utterances and the loss terms derived for the synthetic training canary speech utterances.

4. The method of claim 1, wherein the operations further comprise fine-tuning an automatic speech recognition (ASR) model on supervised training utterances, the ASR model implementing the pre-trained audio encoder and a decoder.

5. The method of claim 1, wherein obtaining the plurality of training canary transcriptions comprises:
sampling, from a training text corpus, the top-N most frequent words that appear in the training text corpus; and
generating each training canary transcription by randomly selecting the predetermined number of words from the top-N most frequent words sampled from the training text corpus.

6. The method of claim 1, wherein obtaining the plurality of training canary transcriptions comprises generating each training canary transcription by selecting a non-repeating permutation of digits.

7. The method of claim 1, wherein obtaining the plurality of training canary transcriptions comprises:
sampling, from a non-native language text corpus, the top-N most frequent words that appear in the non-native language text corpus; and
generating each training canary transcription by randomly selecting the predetermined number of words from the top-N most frequent words sampled from the non-native language text corpus.

8. The method of claim 1, wherein obtaining the plurality of training canary transcriptions comprises generating each training canary transcription as a non-verbal utterance.

9. The method of claim 1, wherein the operations further comprise applying sensitivity-bounded training when pre-training the audio encoder.

10. The method of claim 9, wherein the sensitivity-bounded training comprises per-example clipping wherein gradients of each example in a mini-batch is clipped before being averaged.

11. A system comprising:
data processing hardware; and
memory hardware in communication with the data processing hardware and storing instructions that when executed on the data processing hardware cause the data processing hardware to perform operations comprising:
receiving a training data set comprising un-transcribed speech utterances that each comprise audio-only data not paired with any corresponding transcription;
obtaining a plurality of training canary transcriptions, each training canary transcription comprising a predetermined number of words that are out-of-distribution from words of the un-transcribed speech utterances;
for each training canary transcription, generating, using a text-to-speech (TTS) system, a corresponding synthetic training canary speech utterance that recites the predetermined number of words of the training canary transcription;
pre-training an audio encoder on a combination of the un-transcribed speech utterances and the synthetic training canary speech utterances; and
measuring an un-intended memorization of the pre-trained audio encoder based on encoder labels predicted by the pre-trained audio encoder for the synthetic training canary speech utterances.

12. The system of claim 11, wherein pre-training the audio encoder on the combination of the un-transcribed speech utterances and the synthetic training canary speech utterances comprises:
for each corresponding un-transcribed speech utterance and each synthetic training canary speech utterance:
generating, at each of a plurality of output steps, using a random-projection quantizer, a target quantized vector token and a target token index for a corresponding audio feature in a sequence of audio features associated with the corresponding un-transcribed speech utterance or the corresponding synthetic training canary speech utterance, wherein the target token index maps the corresponding audio feature to the target quantized vector token stored in one or more codebooks;
after masking a subset of the audio features in the sequence of audio features associated with the corresponding un-transcribed non-synthetic speech utterance or the corresponding synthetic training canary speech utterance, generating, by the audio encoder, contrastive context vectors from corresponding masked audio features; and
deriving a loss term between the contrastive context vectors at the masked positions and the target token index; and
pre-training the audio encoder based on the loss terms derived for each of the un-transcribed speech utterances and the synthetic training canary speech utterances.

13. The system of claim 11, wherein measuring the un-intended memorization of the pre-trained audio encoder comprises:
obtaining a plurality of unseen canary speech utterances, each unseen canary speech utterance comprising words that are out-of-distribution from the words of the un-transcribed speech utterances;
for each corresponding unseen canary speech utterance and each corresponding synthetic training canary speech utterance:
generating, at each of a plurality of output steps, using a random-projection quantizer, a target quantized vector token and a target token index for a corresponding audio feature in a sequence of audio features associated with the corresponding unseen canary speech utterance or the corresponding synthetic training canary speech utterance, wherein the target token index maps the corresponding audio feature to the target quantized vector token stored in one or more codebooks;
after applying a word-level mask masking a subset of the audio features in the sequence of audio features associated with a word in the corresponding unseen canary speech utterance or the corresponding synthetic training canary speech utterance, generating, by the audio encoder, contrastive context vectors from corresponding masked audio features, wherein the contrastive context vectors comprise the predicted encoder labels; and
deriving a loss term between the contrastive context vectors at the masked word positions and the target token index; and
measuring the un-intended memorization of the pre-trained audio encoder based on a comparison between the loss terms derived for the unseen canary speech utterances and the loss terms derived for the synthetic training canary speech utterances.

14. The system of claim 11, wherein the operations further comprise fine-tuning an automatic speech recognition (ASR) model on supervised training utterances, the ASR model implementing the pre-trained audio encoder and a decoder.

15. The system of claim 11, wherein obtaining the plurality of training canary transcriptions comprises:
sampling, from a training text corpus, the top-N most frequent words that appear in the training text corpus; and
generating each training canary transcription by randomly selecting the predetermined number of words from the top-N most frequent words sampled from the training text corpus.

16. The system of claim 11, wherein obtaining the plurality of training canary transcriptions comprises generating each training canary transcription by selecting a non-repeating permutation of digits.

17. The system of claim 11, wherein obtaining the plurality of training canary transcriptions comprises:
sampling, from a non-native language text corpus, the top-N most frequent words that appear in the non-native language text corpus; and
generating each training canary transcription by randomly selecting the predetermined number of words from the top-N most frequent words sampled from the non-native language text corpus.

18. The system of claim 11, wherein obtaining the plurality of training canary transcriptions comprises generating each training canary transcription as a non-verbal utterance.

19. The system of claim 11, wherein the operations further comprise applying sensitivity-bounded training when pre-training the audio encoder.

20. The system of claim 19, wherein the sensitivity-bounded training comprises per-example clipping wherein gradients of each example in a mini-batch is clipped before being averaged.
